(19) United States
(12) Patent Application Publication
(10) Pub. No.: US 2013/0132372 A1
(43) Pub. Date: May 23, 2013

(54) SYSTEMS AND METHODS FOR DYNAMIC SERVICE INTEGRATION

(71) Applicant: William B. Gilbert, Mount Pleasant, SC (US)

(72) Inventor: William B. Gilbert, Mount Pleasant, SC (US)

(73) Assignee: BENEFITFOCUS.COM, Charleston, SC (US)

(21) Appl. No.: 13/299,112

(22) Filed: Nov. 17, 2011

(51) Int. Cl. G06F 17/30

(52) U.S. Cl. 707/722; 707/769; 707/E17.014

(57) ABSTRACT

The client may access a wide variety of data sources without extensive customization. A service integration module comprises a plurality of service records, each of which is associated with a respective data source. The service integration module may be configured to manage data source integration including data source drivers, credentials, and connection information. In response to a service request from a client, the service integration module identifies a service record, generates a data source query, accesses a result of the query, and transmits the result to the client. The service integration module may map raw data returned from a data source into a standard format. The service integration module may also reformat the results into a format or data encoding specified by the client.

### TECHNICAL FIELD

This disclosure relates to the creation and provisioning services and, in particular, to dynamic integration of data sources and clients.

### BRIEF DESCRIPTION OF THE DRAWINGS

FIG. 1 depicts an exemplary service record data structure and an exemplary data source record data structure;

FIG. 2 is a block diagram of one embodiment of a system for providing dynamic service integration; and

FIG. 3 is a flow diagram of one embodiment of a method for dynamic service integration;

FIG. 4 is a flow diagram of another embodiment of a method for dynamic service integration;

FIG. 5 is a flow diagram of another embodiment of a method for dynamic service integration; and

FIG. 6 is a flow diagram of another embodiment of a method for dynamic service integration.

### DETAILED DESCRIPTION

Modern information technology systems increasingly rely on access to different types of data sources. Adapting clients to use different data sources, however, can be a time-consuming and error-prone task. Although some data sources and/or services publish service descriptions, clients that wish to use these services still must be customized in accordance with the service description. Moreover, this customization overhead is multiplied when many different clients must be adapted to access different data sources.

The systems and methods disclosed herein may be used to minimize or even eliminate the customization overhead required to integrate clients with different types of data sources. A user may leverage the systems and methods for dynamic service integration disclosed herein to integrate clients with a wide variety of data sources with minimal knowledge of the underlying technologies and/or data formats and/or communication mechanisms used by the data sources. New data sources and services may be made available as soon as they are registered, such that there is no compilation and deployment delay.

In some embodiments, a service integration module may simplify client access to one or more data sources. The service integration module may register one or more data sources in respective data source records. Each data source record may comprise information pertaining to a particular data source. A data source record may include, but is not limited to: a driver of the data source, data source credentials, data source connection information, and the like. As used herein, a driver of a data source refers to a component or library (e.g., computer-readable instructions) that is configured to interact with a particular type of data source. A driver may include, but is not limited to: a Java Database Connectivity (JDBC) driver, an Object Database Connectivity (ODBC) driver, a Structured Query Language (SQL) database driver, a semantic data source connectivity driver, or the like. A data source record may comprise a reference or link to a data source driver as opposed to the driver itself. Data source credentials may be used to authenticate to the data source. Data source credentials may comprise a user name, password, PIN, certificate, key, or the like. Data source connection information may comprise a connection string or other information used to initiate a connection to a particular data source (using the corresponding driver). The connection string may comprise the address of the data source (e.g., URL of the data source), identify a data source name (e.g., table or database name), specify a data source driver, and so on.

The service integration module may provide access to data sources through one or more services. The service integration module may register one or more services using respective service records. A service record may include, but is not limited to: an identifier, a data source (e.g., a reference to a data source record), a parameterized query, a result mapping, or the like. A service may reference one or more data sources. A data source may be used by (e.g., referenced) by a plurality of different services.

A parameterized query of a service may comprise a query string (or other query format), which may include one or more parameter placeholders. The placeholders may be replaced with parameters of a service request to form a data source query. As used herein, a “service request” refers to a request directed to a service and/or data source. A service request may comprise one or more request parameters, a service identifier or name, authentication credentials, and the like. One or more of the request parameters may be inserted into a parameterized query to generate a data source query. As used herein, the term “data source query” refers to a query configured for use with a particular data source. For example, a parameterized query to search for a particular person in a Structured Query Language (SQL) database may comprise, “select*from TABLE where FIRST_NAME=% search_parameter %.” The value of “% search_parameter %” may be replaced with a parameter from the service request. In some embodiments, generating the data source query may further comprise reformatting one or more of the request parameters into a format that is suitable for a particular data source. For example, a request parameter may be converted from a UTF-8 encoding to an ASCII encoding, or the like.

The result mapping of a service record may comprise a mapping between raw result data returned from a data source and a standardized data format. The standardized format may include, but is not limited to: eXtensible Markup Language (XML), Javascript Object Notation (JSON), YAML, Resource Description Format (RDF), such as Terse RDF Triple Language (Turtle), delimited text, a combination of formats, or the like. In some embodiments, results may be converted into an alternative format or encoding. The conversion may be specified in a service request. For example, a result may be converted into a binary format, a particular text encoding (e.g., ASCII, UTF-8, or the like), or the like. For example, a service request may specify that results in an XML standard format be encoded using UTF-8 character encoding.

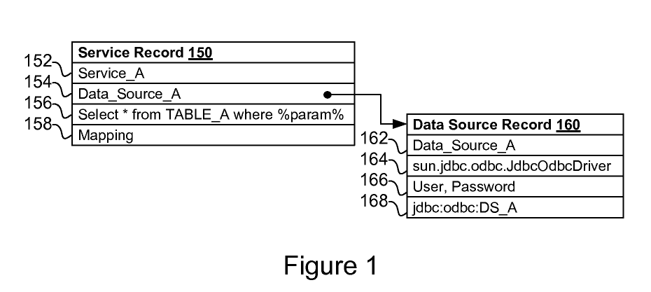

FIG. 1 depicts an exemplary service record data structure and an exemplary data source record data structure. The exemplary service record data structure 150 includes an identifier 152, a data source reference 154, a parameterized query 156, and a result mapping 158. The data source reference 154 may reference a data source record 160, which comprises a data source identifier 162, a driver 164, data source credentials 166, and connection information 168 (e.g., a connection string). Alternatively, or in addition, the data source record 160 may be incorporated into one or more fields of the service record data structure 150.

The data structures 150 and 160 may be embodied on a non-transitory computer-readable storage medium, such as a hard disk, non-volatile memory, or the like. Although FIG. 1 depicts exemplary data structures 150 and 160, the disclosure is not limited in this regard and could be adapted to use any suitable data structure in any suitable format.

Clients may access services of the service integration module using any suitable request mechanism. In some embodiments, a client accesses a service of the service integration module using a Hyper Text Transfer Protocol (HTTP) GET request. The GET request may identify the requested service and/or may comprise one or more request parameters. In response to the service request, the service integration module identifies a service record, generates a data source query, accesses a result of the data source query (e.g., in a data store or a results cache), and transmits the result to the client. The service integration module may also map the results to a standardized format and/or convert the results, as described above.

In some embodiments, the service integration module is configured to cache the results of data source requests. The service integration module may serialize the results into a format suitable for storage on a storage media, and may place the serialized results in a cache in association with the data source query and/or one or more of the request parameters. Subsequent service requests for the same results (with the same request parameters and/or resulting in an equivalent data source query) may be returned from the results cache. In some embodiments, cached results are stored for a pre-determined time period and/or according to a caching policy (e.g., least recently used (LRU), or other suitable caching policy). In some embodiments, the service integration module 210 may remove invalid (e.g., dirty) entries from the cache in response to other storage operations on the data source, such as a write and/or modify.

In some embodiments, a service request may comprise an aggregate request, which comprises a request for multiple sets of data from one or more data sources. An aggregate request may comprise issuing a plurality of queries to a data source (or accessing multiple entries of a results cache), each query resulting on one or more results. An aggregate request may comprise a plurality of delimited request parameters (e.g., GET request parameters), each of which may be applied to the parameterized query of the service to generate a different respective data source query and corresponding result. Each of the results may be mapped to a standardized format and/or converted, as described above, and the results may be aggregated and returned to the client. In some embodiments, the aggregate results are serialized and cached, as described above. The results may be cached in the aggregate and/or as individual data source queries.

Some embodiments may comprise a presentation module that is configured to automatically generate a graphical representation of the result for presentation on a display device. The graphical representation may include, but is not limited to: a chart, a graph, a combination of graphical representations, or the like. Alternatively, or in addition, the presentation module may generate a text representation of the result in a particular format, such as a table format, columnar format, spreadsheet format, or the like.

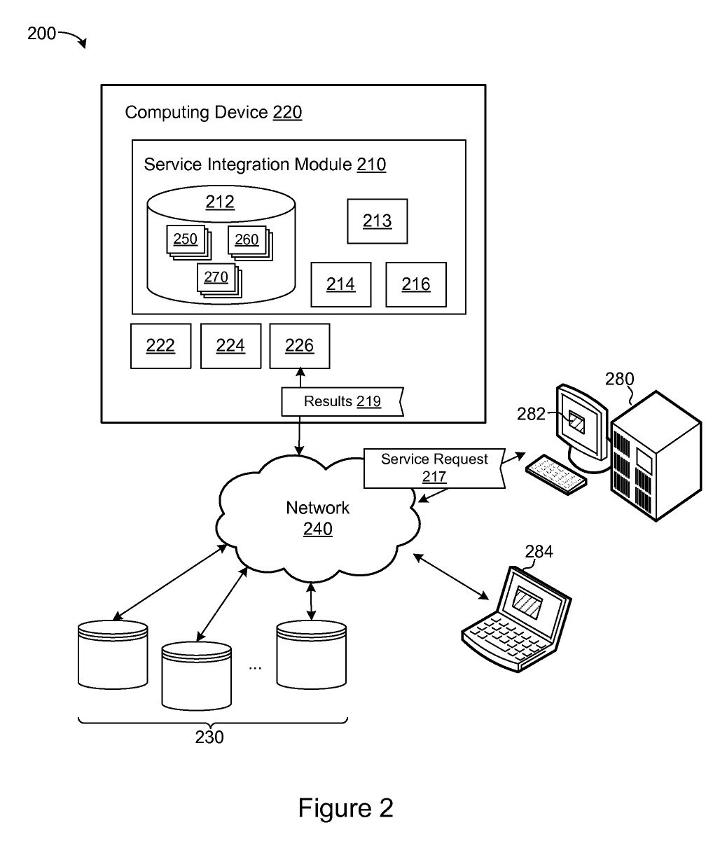

FIG. 2 is a block diagram of one embodiment of a system 200 for dynamic service integration. The system 200 may comprise a service integration module 210 operating on a computing device 220. The computing device 220 may comprise a processor 222, memory, non-transitory storage media 224 (e.g., hard disk, solid-state storage, etc.), a communication interface 226, and the like. In some embodiments, the service integration module 210 is embodied as instructions stored on the non-transitory storage media 224 that are configured to be executed on the processor 222. Although FIG. 2 depicts the service integration module 210 operating on a single computing device 210 having a single processor 222, the disclosure is not limited in this regard. In some embodiments, the system 200 may comprise a plurality of service integration modules 210 operating on a plurality of computing devices 210 (or virtual computing devices) in a clustered and/or high-availability environment.

The service integration module 210 may be communicatively coupled to one or more data sources 230 via a network 140. The data sources 230 may each operate on respective server computers, clusters, or other suitable computing devices. The network 140 may comprise any suitable communication network and may include, but is not limited to: an Internet-Protocol (IP) network, the Internet, a Local Area Network (LAN), Wide Area Network (WAN), a wireless network, a cellular data network, a Public Switched Telephone network (PSTN), or the like.

Although FIG. 2 depicts exemplary network-accessible data sources 230, the disclosure is not limited in this regard. In some embodiments, the system 200 may comprise one or more local data sources in addition to (or in place of) network accessible data sources 230. The local data sources may be communicatively coupled to the service integration module 210 and/or computing device 220 via one or more busses, or other communication links (e.g., Universal Serial Bus, IEEE 1394, SCSI, Peripheral Component Interconnect (PCI), or the like).

The service integration module 210 may comprise a data store 212 upon which is stored one or more service records 250 and/or one or more data source records 260. Each data source record 260 may comprise an identifier, driver, credentials, and connection information, as described above. Each service record 250 may comprise an identifier, data source (reference to a data source record 260), parameterized query, and result mapping, as described above. In some embodiments, the data store 212 may comprise a results cache 270 to cache results of one or more data source queries, as described above.

The service integration module 210 may be configured to add a new data source record 260 to the data store 212 in response to an add data source request comprising a data source identifier, driver, credentials, connection information, and the like. In some embodiments, the service integration module 210 validates that the new data source can be contacted with the provided information before adding a corresponding data source record 260 to the data store 212.

In some embodiments, the service integration module 210 comprises a service registration interface 214 (e.g., web interface) through which users may create, edit, or otherwise manage data source records 260 and/or service records 250. The service integration module 210 may be configured to add a new service record 250 and/or data source record 260 to the data store 212 through the service registration interface 214. A request to add a service record 250 may comprise an identifier, data source, parameterized query, result mapping, and so on. In some embodiments, the service integration module 210 validates the service before adding a new service record 250 to the data store 212. Validating the service may comprise determining whether the specified data source exists in the data store 212, validating the data source, validating the parameterized query (e.g., validating the syntax of the query, testing the query against the data source with one or more test parameters, and so on), and/or validating the result mapping (e.g., validating the syntax of the mapping, etc.). Validating the service may further comprise authenticating the request to ensure that the client is authorized to add a new service record.

The service registration interface 214 may allow users to specify result mappings between raw data types of one or more of the data sources 230 and standardized data formats. The mappings may be applied to one or more service records 250 as described above. The service registration interface 214 may be configured to test one or more services and/or data sources by testing a connection to one or more data sources 230, running test queries through one or more services, and so on. In some embodiments, the service registration interface 214 may also allow a user to specify a policy for the results cache 270. The cache policy may comprise an age-out time, a maximum cache capacity, a LRU policy, or the like.

Data sources and services may be added to the service integration module 210 at registration time. As such, new data sources and/or services may be available for use as soon as corresponding data source records 260 and/or service records 250 are created in the data store 212.

The service integration module 210 may comprise a service interface 216 that is configured to present the one or more services registered with the service integration module 210 to clients 280 via the network 140. As used herein, a “client” refers to a client computing device, which may include, but is not limited to: a personal computing device, a laptop, a notebook, a netbook, a tablet, a Personal Digital Assistant (PDA), a smart phone, or the like. In some embodiments, the service integration module 210 may associate each service record 250 with a respective Uniform Resource Identifier (URI). Clients 280 may direct requests to a particular service using the URI. The URI of a service record 250 may be derived from an identifier of the service record. For instance, if the host name of the service interface 216 is “service.com,” the URI of a serviced identified as “Service_A” may be “service.com/services/Service_A.” In some embodiments, a service may be identified by a request parameter. For example, an HTTP request directed to the service interface 216 may comprise “service identifier” parameter having the value “Service_A.” Although exemplary mechanisms for registering and/or presenting services are described herein, the disclosure is not limited in this regard and could be adapted to use any suitable registration mechanism.

In some embodiments, the service interface 216 provides a listing or directory of the available services and/or data sources. The service interface 216 may enumerate the parameters of one or more registered services and/or may provide exemplary service requests. The service interface 216 may be further configured to provide service mapping information and/or specify the standardized format in which the results of a service may be returned. The service interface 216 may allow clients 280 to edit and/or modify one or more of the services through the service registration interface 214 as described above.

The service interface 216 is configured to receive service requests 217 from one or more clients 280. The service interface 216 may receive service requests 217 using any suitable mechanism including, but not limited to: HTTP, Simple Object Access Protocol (SOAP), Remote Procedure Call (RPC), Remote Method Invocation (RPC), or the like.

Upon receiving a service request 217, the service integration module 210 may validate the request 217, which may comprise validating the request syntax, validating request parameters, and so on. In some embodiments, access to the service integration module 210 is restricted to authenticated users. The service integration module 210 may comprise and/or be communicatively coupled to a user database, directory, or the like (not shown). Validating the service request 217 may comprise authenticating credentials in the service request 217, such as a user name and password, PIN, digital signature, or the like.

Upon validating the service request 217, the service integration module 210 may identify a corresponding service record 250, as described above. The service integration module 210 may identify the service record 250 based upon the URI to which the request 217 was directed, a parameter of the service request 217, or the like.

The service integration module 210 may generate a data source query using the parameterized query of the identified service record 250 and/or parameters of the service request 217. Generating the data source query may comprise inserting one or more request parameters of the service request 217 into the parameterized query of the service record 250. In some embodiments, the request parameters may be formatted and/or encoded into a suitable format for the data source 230.

The service request 217 may comprise a request for multiple sets of data. For example, the service request 217 may comprise multiple sets of request parameters. In response to such a request, the service integration module 210 may generate a plurality of different data source queries, each comprising a respective set of request parameters. The request parameters may be delimited by a particular character and/or denoted by the format of the service request 217.

The service integration module 210 may use the data source query to generate and/or transmit a result to the client. In some embodiments, the service integration module 210 determines whether the result is cached in the results cache 270. If so, the service integration module 210 may transmit the cached result to the client, without querying a data source 230.

If the results are not found in the cache 270 (or the cached results are invalid), the service integration module 210 may access the result from a data source 230 via the network 240. The service integration module 210 may access the data source 230 using the driver, credentials, and/or connection information of the data source record 260 referenced by the service record 250. The service integration module 210 may transmit a response 219 to the client query 217 that includes the result.

In some embodiments, the service integration module 210 is further configured to apply a result mapping of the service record 250 that maps the result acquired from the data source 230 to a standardized format, as described above. The response 219 may include the result in the standardized format. In some embodiments, the service integration module 210 may be configured to format the results into a format specified in the service request 217. As described above, the format may comprise a binary format, a text format, or other format suitable for use by the client 280.

The service integration module may be configured to cache the result in the result cache 270. Caching the result may comprise “serializing” the result into a format suitable for storage on a non-transitory computer-readable storage medium and associating the serialized result with the result query. The serialized result may be associated with cache management data, such as a last access time, access frequency metric, expiration time, or the like.

The client 280 may receive the response 219 and extract the results therefrom. In some embodiments, the client 280 comprises a client presentation module 282 that is configured to present the results 219 on one or more human-machine interface components of the client 280, such as displays, audio outputs, or the like. The client presentation module 282 may be configured to present the results graphically, textually, or the like. In some embodiments, the client presentation module 282 is available from the service integration module 210 and/or is accessible via the network 240 (e.g., the client presentation module 282 may comprise an applet provided by the service integration module 210).

The client presentation module 282 may be configured to select a suitable graphical representation format for the results 219. The graphical representation format may include, but is not limited to: a chart, a graph, a text-based format (e.g., a table format, columnar format, spreadsheet format, etc.), a combination of formats, or the like. The client presentation module 282 may select a graphical representation format based upon the “structure” of the results 219, such as the number and/or type of variables represented in the results 219, the number of input/output variables of the results 219, parameters of the service request 217, and so on. Accordingly, the client presentation module 282 may be configured to analyze the results 219 to select a suitable graphical representation format. The selection may be based upon one or more user-defined selection criteria or preferences.

Alternatively, or in addition, the service integration module 210 may comprise a server-side presentation module 213 that is configured to automatically generate a graphical representation of the results 219 for presentation on the client 280. The server-side presentation module 213 may automatically select a suitable graphical representation format for the results 219, as described above. The formatted results may be provided to the client 280 for presentation thereon.

In some embodiments, the client 280 may comprise a server computing device that is configured to present results obtained from the service integration module to one or more clients 284 via the network 240. For example, the client 280 may comprise a web server that is configured to aggregate and publish the results to a plurality of client computing devices 284.

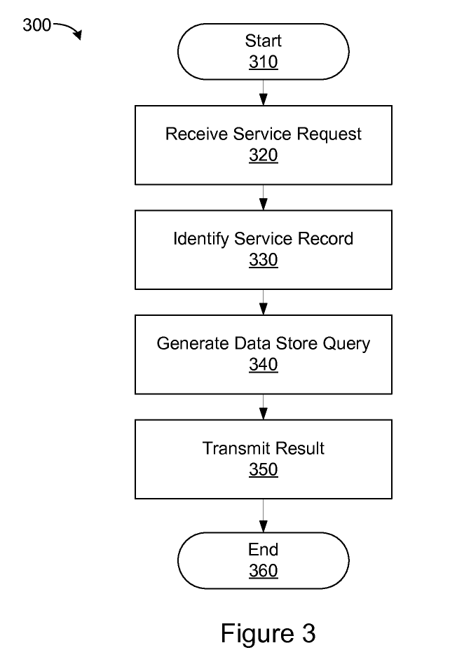

FIG. 3 is a flow diagram of one embodiment of a method 300 for dynamic service integration. At step 310, the method 300 starts and is initialized. The method 300 may be embodied as computer-readable instructions on a non-transitory storage medium. Accordingly, step 310 may comprise loading one or more computer-readable instructions and/or executing the one or more instructions on a computing device. One or more of the steps of the method 300 may be tied to particular machine components, such as communications interfaces, computer-readable storage media, and the like. Step 310 may, therefore, comprise accessing and/or initializing these machine components.

At step 320, the method 300 may receive a service request via a network communication interface. The service request may comprise a service identifier and/or one or more request parameters. The service identifier may be used to identify a service record and/or data source record at step 330, as described above. The service record and/or data source record identified at step 320 may be stored on a non-transitory computer-readable storage medium of a computing device.

Step 340 may comprise generating a data source query using a parameterized query of the service record and/or one or more of the request parameters of the service request. Step 340 may comprise inserting one or more request parameters into the parameterized query. In some embodiments, step 340 comprises formatting and/or encoding one or more of the request parameters into a format suitable for a particular data source. Step 340 may further comprise using the data source query to access a result. In some embodiments, the result is accessed from a result cache. Alternatively, or in addition, the result may be accessed from a data source. Accessing the result from the data source may comprise issuing a query to the data source using a driver, credentials, and/or connection information of the data source record identified at step 330.

Step 350 may comprise transmitting the result to a client over a network. In some embodiments, step 350 comprises applying a result mapping of the service record to map raw result data into a standardized format. Step 350 may further comprise converting the result into a suitable format for the client, as described above. In some embodiments, step 350 may further include including the results in a results cache, as described above.

At step 360, the method 300 ends until another service request is received.

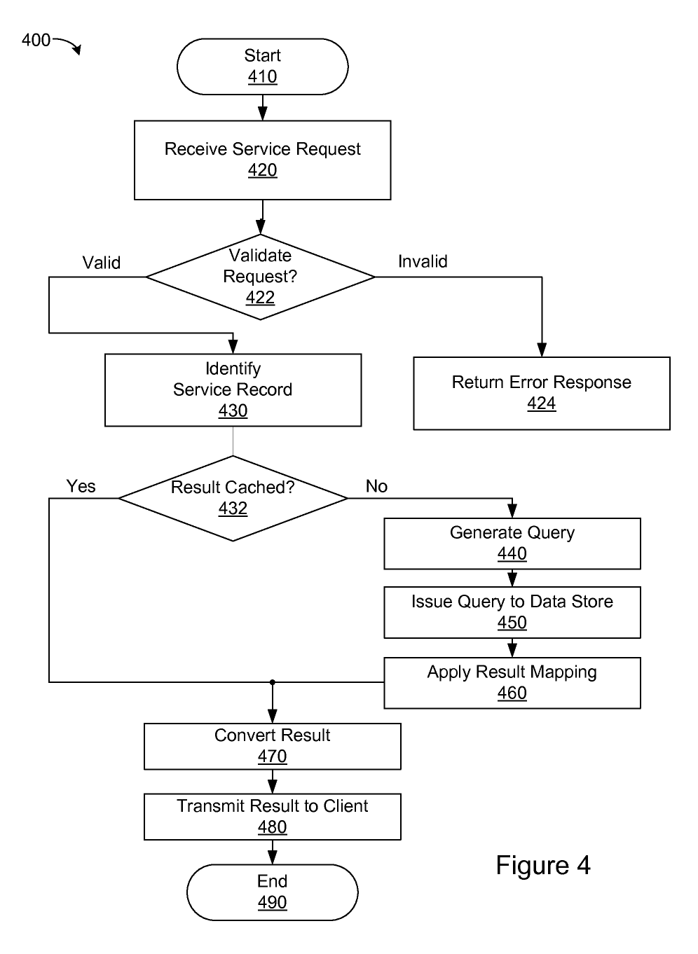

FIG. 4 is a flow diagram of another embodiment of a method 400 for providing dynamically service integration.

At step 410, the method 400 starts and is initialized. The method 400 may be embodied as computer-readable instructions on a non-transitory storage medium. Accordingly, step 410 may comprise loading one or more computer-readable instructions and/or executing the one or more instructions on a computing device. One or more of the steps of the method 400 may be tied to particular machine components, such as communications interfaces, computer-readable storage media, and the like. Step 410 may, therefore, comprise accessing and/or initializing these machine components. Step 420 comprises receiving a service request, as described above.

At step 422 the service request may be validated. Validating the service request may comprise validating the syntax of the request, validating credentials of the request (e.g., verifying that the request is from an authorized client), or the like. Step 422 may comprise accessing a user directory or database, validating a digital signature, or the like. Step 422 may further comprise validating that the service request references a valid service record and/or data source record. If the service request is validated, the method 400 may continue to step 430; otherwise, the method 400 may continue at step 424.

Step 424 may comprise returning an error response to the client. Step 424 may comprise generating an error response that indicates the nature of the error, provides instructions on how to address the error in subsequent service requests, or the like.

At step 430, the method 400 identifies a service record corresponding to the service request as described above. At step 432, the method 400 may determine whether a result of the service request is available in a results cache. Step 432 may comprise querying the results cache with one or more request parameters of the service request (or a data source query). Step 432 may further comprise determining if a cached result is valid (e.g., has not expired, is not “dirty,” and so on). If a valid result is available in the cache, the method 400 continues at step 470; otherwise, the method 400 continues at step 440.

Step 440 comprises generating a data source query for the service request. Step 440 may comprise inserting one or more request parameters into a parameterized query of the service record identified at step 430. Step 430 may further comprise reformatting and/or encoding one or more of the request parameters into a format that is suitable for the data source.

Step 450 may comprise issuing a query to the data source using a driver, credentials, and/or connection information of the data source record referenced in the service record. Step 450 may further comprise receiving a response to the query from the data source. Step 460 comprises applying a result mapping to the raw data returned from the data source, as described above. In some embodiments, step 460 further comprises caching the result in a results cache.

In some embodiments, the method 400 further comprises converting the result into a format specified in the service request at step 470, as described above. The result may be transmitted to a client computing device using a network interface at step 480. At step 490, the method 400 ends until a next service request is received.

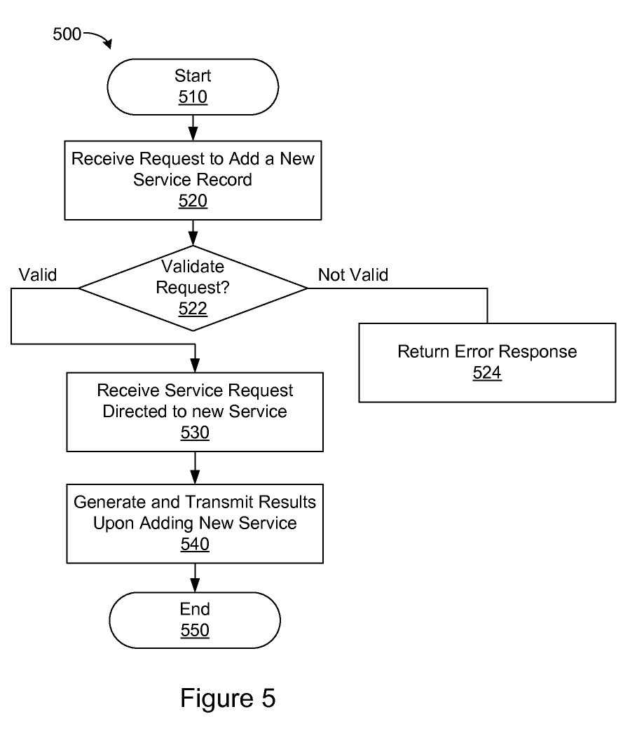

FIG. 5 is a flow diagram of another embodiment of a method for dynamic service integration. At step 510, the method 500 starts and is initialized. The method 500 may be embodied as computer-readable instructions on a non-transitory storage medium. Accordingly, step 510 may comprise loading one or more computer-readable instructions and/or executing the one or more instructions on a computing device. One or more of the steps of the method 500 may be tied to particular machine components, such as communications interfaces, computer-readable storage media, and the like. Step 510 may, therefore, comprise accessing and/or initializing these machine components.

A request to add a new service record is received at step 520. The request may be received from a client via a network interface. The request of step 520 may comprise a service identifier, parameterized query, a result mapping, reference a data source, and/or specify a data source identifier, driver, credentials, and/or connection information.

Step 522 may comprise validating the request, which may comprise checking the syntax of the request, verifying credentials of the request to determine whether the request is from an authorized client, and so on. If the request is valid, the method 500 may continue to step 530. In some embodiments, validating the request further comprises storing the new service record (and/or new data source record) on a non-transitory computer-readable storage medium. The new service may be available immediately upon being validated at step 522. Accordingly, the new service may be available without compilation and/or deployment delay.

If the request is not validated, the method 500 may continue to step 524, where an error response is returned to the client. The error response may indicate the nature of the error and/or indicate how the error may be addressed in subsequent requests.

Step 540 comprises receiving a service request directed to the new service request as described above. Step 550 may comprise generating a result in response to the service request and transmitting the result to a client, as described above. Steps 540 and 550 may occur immediately upon validating the new service record at step 522.

The method 500 ends at step 550 until another service request is added and/or another service request is received.

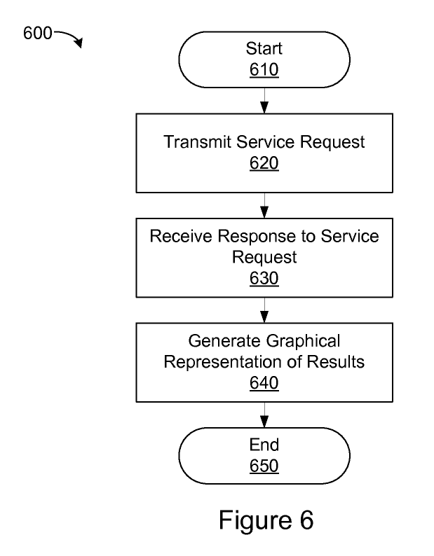

FIG. 6 is a flow diagram of another embodiment of a method for dynamic service integration. At step 610, the method 600 starts and is initialized. The method 600 may be embodied as computer-readable instructions on a non-transitory storage medium. Accordingly, step 610 may comprise loading one or more computer-readable instructions and/or executing the one or more instructions on a computing device. One or more of the steps of the method 600 may be tied to particular machine components, such as communications interfaces, computer-readable storage media, and the like. Step 610 may, therefore, comprise accessing and/or initializing these machine components.

At step 610, a client computing device transmits a service request to a network-accessible service integration module. The service request may comprise a service identifier and one or more request parameters. The service request may be independent of the data source that will be queried to access results of the request. Accordingly, the service request may be generated in a simple format, such as HTTP, SOAP, or the like. The service request may not include nor reference a data source driver, data source credentials, or the like. In some embodiments, the service request may specify the format and/or encoding for the results of the request (e.g., ASCII text, UTF-8, etc.).

In some embodiments, the service request of step 620 is generated by an application operating on the computing device. Alternatively, or in addition, the service request may be generated and/or transmitted by a component of a Web server that is configured provide content to one or more client component devices.

At step 630, the client computing device receives a response to the service request comprising results in a standardized format, such as XML, JSON, YAML, RDF, Turtle, or the like. The results may be formatted and/or encoded as specified in the service request. The response received at step 630 may be generated by a service integration module, as described above.

At step 640, the client computing device may automatically generate a graphical representation of the results. The graphical representation may comprise any suitable graphical representation format including, but not limited to: a chart, a graph, a text-based representation, a combination of graphical representation formats, or the like. In some embodiments, step 640 comprises selecting a graphical representation format based upon the results obtained at step 630 (e.g., select a format suited to displaying the results). The selection may be based upon the “structure” of the results. Accordingly, step 640 may comprise analyzing the results based upon user-defined selection criteria, as described above. Alternatively, in some embodiments, the graphical representation may be generated by the network-accessible service integration module, as described above.

In some embodiments, step 640 comprises presenting the graphical representation on a display device. The graphical representation may comprise user interface components configured to receive user input. Step 640 may comprise modifying the graphical representation in response to user input received through the user interface components. For example, step 640 may comprise zooming in to a portion of the graphical representation, panning within the graphical representation, changing the type of graphical representation (e.g., graph to pie chart), and so on. In some embodiments, the user interface components may be configured to receive request parameters and/or allow a user to cause the computing device to transmit another service request at step 620. In response to receiving a response to the new service request, the graphical representation may be updated and presented to the user at steps 630 and 640.

At step 650, the flow ends until a next service request is transmitted to the service interface module.

The above description provides numerous specific details for a thorough understanding of the embodiments described herein. However, those of skill in the art will recognize that one or more of the specific details may be omitted, or other methods, components, or materials may be used. In some cases, operations are not shown or described in detail.

Furthermore, the described features, operations, or characteristics may be combined in any suitable manner in one or more embodiments. It will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps, or by a combination of hardware, software, and/or firmware.

Embodiments may also be provided as a computer program product including a computer-readable storage medium having stored instructions thereon that may be used to program a computer (or other electronic device) to perform processes described herein. The computer-readable storage medium may include, but is not limited to: hard drives, floppy diskettes, optical disks, CD-ROMs, DVD-ROMs, ROMs, RAMs, EPROMs, EEPROMs, magnetic or optical cards, solid-state memory devices, or other types of medium/machine-readable medium suitable for storing electronic instructions.

As used herein, a software module or component may include any type of computer instruction or computer executable code located within a memory device and/or computer-readable storage medium. A software module may, for instance, comprise one or more physical or logical blocks of computer instructions, which may be organized as a routine, program, object, component, data structure, etc., that perform one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

It will be understood by those having skill in the art that many changes may be made to the details of the above-described embodiments without departing from the underlying principles of the invention.

We claim:

1. A method for dynamic service integration, comprising:
receiving a service request from a client at a computing device, the service request comprising a service identifier and one or more request parameters;
identifying one of a plurality of service records using the service identifier, the service record comprising a parameterized query and referencing one of a plurality of data source records, wherein the plurality of service records and the plurality of data source records are stored on a non-transitory computer-readable storage medium;
inserting one or more of the request parameters into the parameterized query to generate a data source query; and
transmitting a result of the data source query to the client on a network interface of the computing device.

2. The method of claim 1, further comprising applying a result mapping of the service record to map raw data of a data source to a standardized format.

3. The method of claim 1, further comprising applying a result mapping of the service record to map raw data of a data source to one of an eXtensible Markup Language format, a Javascript Object Notation format, a YAML format, Resource Description Format (RDF), Terse RDF Triple Language, and a delimited text format.

4. The method of claim 1, further comprising formatting the result into a format specified in the service request.

5. The method of claim 1, further comprising accessing the result in a results cache of the computing device using the data source query.

6. The method of claim 1, further comprising:
serializing the result; and
caching the serialized result in a results cache of the computing device in association with the data source query.

7. The method of claim 1, further comprising issuing the data source query to a data source using a driver, credentials, and connection information of the data source record referenced by the identified service record.

8. The method of claim 1, wherein the service identifier comprises a Uniform Resource Identifier of the service request.

9. The method of claim 1, wherein the service identifier comprises a parameter of the service identifier.

10. The method of claim 1, further comprising authenticating the service request using a credential included in the service request.

11. The method of claim 1, further comprising:
adding a new service record to the computer-readable storage media, the service record referencing a new data source record on the computer-readable storage media;
receiving a service request identifying the new service record and transmitting a result of a data source query to a data source of the new data source record upon adding the new service record.

12. The method of claim 1, further comprising presenting a graphical representation of the result on a display.

13. The method of claim 1, further comprising:
selecting a graphical representation format based upon a structure of the result; and
presenting a graphical representation of the result in the selected graphical representation format on a display.

14. A non-transitory computer-readable storage medium comprising instructions configured to cause a computing device to perform a method for dynamic service integration, the method comprising:
receiving a service request from a client comprising a service identifier and one or more request parameters;
identifying one of a plurality of service records using the service identifier the service record comprising a parameterized query and referencing one of a plurality of data source records;
inserting one or more of the request parameters into the parameterized query to generate a data source query; and
accessing a result of the data source query from one of a results cache and a data source; and
transmitting the result to the client via a network.

15. The computer-readable storage medium of claim 14, the method further comprising mapping the result to a standardized format.

16. The computer-readable storage medium of claim 14, the method further comprising reformatting the result into a requested format.

17. The computer-readable storage medium of claim 14, the method further comprising:
serializing the result; and
caching the serialized result in a results cache in association with the data source query.

18. The computer-readable storage medium of claim 14, the method further comprising issuing the data source query to a network-accessible data source using a driver, credentials, and connection information of the data source record.

19. The computer-readable storage medium of claim 14, wherein the service identifier comprises one of a Uniform Resource Identifier of the service request and a request parameter of the service request.

20. The computer-readable storage medium of claim 14, wherein generating the data source query comprises reformatting one or more of the request parameters.

21. The computer-readable storage medium of claim 14, the method further comprising:
selecting a graphical representation format based upon a structure of the result; and
presenting a graphical representation of the result in the selected graphical representation format on a display.

22. An apparatus for dynamic service integration, comprising:
a computing device comprising a processor, a network interface, memory, and a non-transitory computer-readable storage medium;
a service integration module operating on the computing device, wherein the service integration module is configured to receive a service request from a client on the network interface, the service request comprising a service identifier and one or more request parameters, identify one of a plurality of service records using the service identifier, generate a data source query from a parameterized query of the identified service record and one or more of the request parameters, and to transmit a result of the data source query to the client on the network interface.

23. The apparatus of claim 22, further comprising a results cache comprising a plurality of results of respective data source queries, wherein the service integration module is configured to access the result of the data source query from one of the results cache and a network-accessible data source.

24. The apparatus of claim 22, wherein the service integration module is configured to map a raw result of a data source to a standardized format of the result of the data source query using a results mapping of the service record.

25. The apparatus of claim 22, wherein the service integration is configured to access the result of the data source query from a network-accessible data source using a driver, credentials, and connection information of a data source record of the identified service record.
